(19) United States
(12) Patent Application Publication
(10) Pub. No.: US 2026/0235525 A1
(43) Pub. Date: Aug. 13, 2026

(54) SYSTEM AND METHOD FOR PREDICTIVE NON-HUMAN TESTING OF PROTECTIVE GARMENTS

(71) Applicant: Research Triangle Institute, Research Triangle Park, NC (US)

(72) Inventors: Anthony Clint CLAYTON, Rougemont, NC (US); Howard Jerome WALLS, Apex, NC (US); Roger POPE, Efland, NC (US); Christopher PETERS, Durham, NC (US)

(21) Appl. No.: 19/050,422

(22) Filed: Feb. 11, 2025

(51) Int. Cl. G01N 21/85; A41D 27/00; G01N 21/64

(52) U.S. Cl. CPC G01N 21/85; A41D 27/00; G01N 21/6456

(57) ABSTRACT

A garment robotic interface performance system (GRIPS) and method of use are disclosed. GRIPS is a testing system designed for evaluating protective garment components and subsystems by simulating human movement and motions that stress seams, closures, and interfaces and give real-time leakage assessments. GRIPS comprises an anthropomorphic test manikin of human dimensions and proportions, incorporating means for articulation that replicate life-like motion or movement. Methods include conducting tests designed to closely replicate the conditions of a human-in-the-garment aerosol system test (AST) and improved aerosol system test (I-AST). This allows the testing system to predict the performance of a full ensemble in a human-in-the-garment I-AST, without requiring the use of a human test participant.

### TECHNICAL FIELD

The present invention relates to a system and method of testing protective garment ensembles and subcomponents on a non-human device that simulates human-in-the-garment testing. More specifically, the present invention relates to a garment robotic interface performance system (GRIPS) and method for testing components of garment ensembles (i.e., hood-mask, sleeve-glove, and trousers) during and after exposure to an aerosol challenge.

### BACKGROUND

First responders, public health workers, hazardous material mitigation teams, and military personnel are regularly exposed to, or at risk of exposure to, harmful airborne substances, including toxins, carcinogens, harmful particles, and chemical warfare agents. For instance, firefighters frequently face carcinogenic smoke, a known health hazard that contributes to a significant incidence of cancer in the profession. In addition, despite the adoption of the Chemical Weapons Convention (CWC) in 1997, state actors have continued to employ chemical warfare agents in conflicts, posing ongoing risks to military and civilian personnel alike.

To mitigate these risks, various forms of protective clothing and equipment are employed. First responders typically wear turnout gear, which includes a protective hood, gloves, self-contained breathing apparatus (SCBA), and boots, or hazmat suits. Military personnel are outfitted with mission-oriented protective posture (MOPP) gear, such as a gas mask, hooded shirt, pants, gloves, and boots. While these protective systems are critical for safeguarding personnel, they often impose significant burdens on the wearer, including overheating, reduced dexterity, diminished field of vision, and impaired hearing. These factors not only shorten the duration of time personnel can effectively perform their duties, but also increase the risk of mistakes due to fatigue and diminished cognitive function.

Moreover, even with the use of protective garments, these systems may not provide complete effectiveness, as toxic and carcinogenic substances can still penetrate and reach the skin, eyes, or lungs of the wearer. Interfaces and closures between garment components are particularly vulnerable, as stress is applied to these areas during a person's movement, thereby allowing harmful materials to enter the garment. This stress can compromise the protective seal, reducing the overall effectiveness of the ensemble. A common example is the hood/mask interface (HMI), where head movements exert stress on this complex interface, leading to potential inward leakage.

There is a pressing need for improvements in protective gear to address several challenges, including reducing the burden on the wearer by making protective systems lighter, more breathable, and capable of improved moisture and heat transport to enhance comfort and dexterity. Additionally, protective systems should offer enhanced protection by better preventing the infiltration of harmful materials, thereby reducing the risk of exposure to the skin and mucosa. Ease of donning and doffing is also critical, as protective equipment should be easy for a single individual to put on and take off, minimizing errors that could compromise protection. Finally, contamination control is important, with systems designed to facilitate the safe removal of contaminated gear without transferring harmful substances to the wearer.

While advancements in materials and design are being explored to address these needs, it is essential to rigorously assess the performance of new solutions. This includes evaluating the penetration and infiltration of particles, liquids, and vapors through various components of the protective ensemble, such as rubbers, fabrics, air-permeable membranes, zippers, gloves, masks, and full protective suits. Testing must extend beyond individual materials and components to the complete protective ensemble, as the integration of different components may affect the overall performance. A material or component that performs well in isolation may not necessarily perform effectively when integrated into a full system, especially under conditions that simulate real-world use.

Specifically, when testing aerosols or airborne particles, there is a need to distinguish between the challenge (or threat) simulant and benign aerosol such as dust that may be generated by abrasion and garment motion. Aerosols differ from vapors in that their diffusion rate is not a significant factor in their behavior. Instead, their physical properties, such as particle size and concentration per unit volume of air, are more crucial than their chemical properties. Aerosols are not effectively absorbed by activated carbon, making chemical detectors less useful for detecting their presence and assessing penetration or infiltration rates. Aerosols can penetrate air-permeable fabrics based on filtration principles, and they pass easily through carbon fabrics and activated carbon beds, where vapors would typically be absorbed.

Aerosols follow the path of least resistance, adhering to airflow lines. As a result, gaps in protective garments, such as those created by zipper closures, stitching holes, or interfaces between components (e.g., sleeve-to-glove junctions), can lead to aerosol particle infiltration without any effective removal mechanisms. Therefore, testing for aerosol penetration through protective garments is critical to understanding their performance in preventing exposure.

Established aerosol testing methods for protective materials include several approaches to evaluate fabrics, seams, closures, interfaces, and components. For fabrics and permeable materials, testing involves exposing the material to salt or oil aerosols and measuring particle concentration and/or particle size on both the upstream (challenge) and downstream (protected) sides. This method, similar to air filter testing, assesses the material's particle removal efficiency and its ability to block aerosol penetration.

Although no accepted test standard exists for individual garment components and interfaces, such as the junctions between garments, informal screening methods are occasionally used. These methods typically involve using a static body form, such as a bust, donned with a hooded coat and a full-face respirator or a manikin arm with a coat sleeve and glove, and then challenging it with a fluorescently tagged aerosol to evaluate aerosol penetration at these critical junctions. Data is collected through fluorescent imaging and fluorometry, which visualize deposition patterns and measure the surface concentration of aerosol particles. However, these informal methods are not widely adopted because they fail to replicate the dynamic stresses introduced by human movement.

Current solutions for full-subsystem testing include static manikin busts used for hood and mask testing in aerosol test chambers, such as wind tunnels, and the Visual Outward Aerosol Leakage Test (VOALT) with a manikin. However, these tests have limitations. Static manikin busts offer the advantage of testing multiple items per aerosol challenge using the same facility. However, this approach has a significant limitation, as it does not account for stress on the interface, therefore failing to identify temporary leak paths caused by motion. The VOALT method enables rapid testing of concepts to detect leaks and provides the ability to test modifications in real time with visual feedback. Despite these benefits however, this method has limitations as it does not subject the interface to stress and lacks quantitative measurement capabilities.

To address some of these shortcomings, the Aerosol System Test (AST) and the image-based Improved Aerosol System Test (I-AST) provides a human-in-the-garment assessment of the full protective ensemble. These methods are widely accepted, with published NFPA and Department of Defense (DoD) test procedures. The Test Operations Procedure (TOP) 10-2-022A, “Chemical Vapor and Aerosol System-Level Testing of Chemical/Biological Protective Suits” (Walker, C., 2013), is a standardized methodology developed by the U.S. Army Test and Evaluation Command to evaluate the performance of chemical/biological (CB) protective suits. This procedure provides a detailed framework to ensure consistency, accuracy, and reliability in testing protective garments under controlled conditions.

The AST uses a fluorescently tagged, dry aerosol to challenge a protective garment system and determine the deposition onto the skin. Quantitative sampling of aerosol deposition on skin is provided at discrete locations via a wet-chemistry skin-rinsing method. Visualization of deposition patterns is provided with black light viewing and photography. Although the AST provides effective evaluation of protective garments, the sample collection and analysis is labor intensive, the quantitative data is discrete rather than capturing deposition over the full body, and black-light visualization can be confounded by natural skin fluorescence.

The I-AST uses a powder with fluorescent tags and a phosphor tag that enables quantitative imaging to separate the skin's natural fluorescence from that of the tagged aerosol. The quantitative imaging method of the I-AST was developed to provide an improved image analysis that leverages all the data collected to provide regional data by body region, capturing deposition over the full body, as opposed to discrete sampling of specific locations on the body.

The methods developed under the I-AST program were extended to include methods and analysis for female body types using volunteer female test participants (TPs). Witness garments were developed for both males and females for imaged-based data collection in the undergarment areas. Sampling locations and regional markers are adjusted to account for male/female differences. For example, a female undergarment, such as a sports bra, changes the sweat and aerosol deposition patterns during testing. The regional markers may be adjusted accordingly to account for these different patterns.

Automated processing of the image data to provide skin surface concentrations by anatomical region and a hotspot analysis for each body region was also developed. In a parallel effort, Development Command Chemical Biological Center (DEVCOM CBC) and Army Public Health Center developed an assessment tool to evaluate toxicological effects of chemical warfare agents. This assessment tool accepts surface deposition concentration and hotspot by body region and provides an estimation of toxicological response and resulting health effects that might occur with that concentration, such as severe erythema or reddening of the skin or edema and blistering.

The primary objective of TOP 10-2-022A is to assess a protective suit's ability to prevent the penetration of chemical vapors and aerosols, simulating real-world exposure scenarios. Testing is conducted in controlled environments, such as exposure chambers or wind tunnels, where chemical vapor and aerosol challenges are introduced and blown into the exposure chamber by a fan or other wind source. The procedure specifies detailed methods for detecting and quantifying chemical infiltration, with a focus on key garment features such as closures, seams, and interface points. During the exposure to the tagged aerosol, the test participant performs a prescribed series of motions (motion routines or protocols) that simulate activities in which an end user might engage, for example, standing, walking, running in place, bending, reaching, crawling, dropping to a prone firing position, and rolling onto their back. This routine typically lasts for 30 minutes with a 90-degree rotation every 7.5 minutes, with respect to the wind-blown aerosol challenge, to simulate a change in the wind direction. Performance metrics include the suit's resistance to chemical agents, identification of leakage points, and overall integrity when subjected to operational stresses, such as movement and environmental conditions. Aerosol penetration of garments depends on many variables. These include the garment's fabric and closure properties; the surrounding environment in terms of wind speed and aerosol concentration; and body motions that can create a bellows effect, drawing aerosol particles into the garment. It is important that a test facility and its protocols provide careful control of these variables.

The overall test objective is to measure the aerosol deposition velocity to areas of a test participant's skin after wearing one of several chemical protective ensembles in an aerosol exposure chamber. The test also supports the development, validation, and procurement of protective suits for military personnel, first responders, and others operating in hazardous environments. The presence of a human subject ensures that all aspects of aerosol protection are evaluated. However, these tests are very costly and time-consuming.

Fluorescent Aerosol Sensor Technology (FAST), as described U.S. Pat. Nos. 9,915,600 and 10,018,551 and incorporated herein by reference in their entireties, enhances the accuracy of detecting and analyzing aerosol infiltration in dynamic testing scenarios. These patents disclose a particle detector featuring a housing with a sample inlet and outlet, enclosing a detection cavity, a light source to illuminate particles in a sample fluid, and a photo-responsive material to capture measurement light. The detector collects light scattered or emitted (e.g., via autofluorescence) from particles along multiple angled light paths. It can analyze various fluids, including aerosols, bio-aerosols, and liquids. The FAST provides an aerosol detection mechanism that can differentiate between fluorescent or phosphorescent-tagged (“challenge”) aerosols and inert dust or particles generated by the garment or body part movement.

Testing of protective systems typically involves human participants, which is both time-consuming and costly. However, critical performance issues, particularly those related to closures and interfaces between different components of the ensemble, often become apparent only during full-system testing. Consequently, there is a need for methods that accelerate and reduce the cost of testing individual components and subsystems, while also predicting their performance when tested as part of a complete ensemble worn by a human subject in realistic scenarios.

Despite the availability of various testing methods, challenges remain in assessing the performance of protective garments, particularly with respect to interfaces and closures, where aerosol penetration is most likely to occur. There is a need for improved and efficient testing methods that can better predict real-world performance while reducing time and costs associated with full system human trials.

### SUMMARY OF THE INVENTION

This summary is provided to introduce, in a simplified form, concepts that are further described in the following detailed descriptions. This summary is not intended to identify key features or essential features of the claimed subject matter, nor is it intended to be construed as limiting the scope of the claimed subject matter.

Disclosed herein is a garment robotic interface performance system (GRIPS) and method of use. It is one object of the present invention to provide a testing system and method designed for evaluating protective garment components and subsystems (e.g., boots, socks, pants, coats, hoods, and masks) by simulating human movement and motions that stress seams, closures, and interfaces and give real-time leakage assessments.

According to one or more embodiments, the GRIPS includes body-like surfaces for data collection, preferably with the following properties: (i) non-fluorescing and non-phosphorescing when clean, (ii) curvatures and sizes that correspond to small, medium, and large human body measurements as used in standard garment fitting schemes for that specific body part (e.g., legs and pelvis for pants), (iii) the ability to accumulate aerosol deposits in a manner similar to human skin, while supporting both image-based data collection (fluorescent and/or phosphorescent tagged particles) and surface sampling (e.g., swabbing or rinsing) without introducing interferents, (iv) readily cleanable for reuse after aerosol deposition, and (v) durable enough to support multiple uses while withstanding heavy clothing and protective equipment and also preventing undesirable ingress of aerosol into the system components.

According to one aspect of the present invention, the system for testing protective garments comprises an anthropomorphic manikin designed for biomimetic mechanics and movement comprising at least one human limb component dimensioned to fit standard sizes of protective garments; at least one biomimetic mechanism operably connected to the limb component; a skin-like material removably affixed to an outer surface of the limb component, whereby the skin-like material is designed for mimicking response characteristics of human skin; a control center comprising hardware for executing system test methods; and, a power supply operably connected to the anthropomorphic manikin.

According to another aspect of the present invention, the skin-like material is attached to the manikin with minimal spacing therebetween to minimize the introduction of aerosol into an interface between the skin-like material and the manikin, and the skin-like material provides a surface for the manikin that is cleanable to level such that background fluorescence under black light exposure is less than three times a lower limit of detection.

According to one or more embodiments, the biomimetic mechanism is a means for articulation comprising at least one motor operably connected to the manikin; at least one circuit board operably connected to the motor; and, whereby the control center includes at least one microprocessor configured to transmit signals to the circuit board for execution of programmable motion protocols that activate predetermined biomimetic responses.

According to yet another aspect of the present invention, the system includes a real-time aerosol detection mechanism comprising an aerosol detector configured to identify an increase in aerosol concentrations within a protective garment in relation to a speed of motion and manikin position during movements; sampling points having a spatial distribution and placement location on the manikin corresponding to standard sampling points used in human aerosol testing; aerosol sampling lines operably connecting the sampling points of the manikin to the aerosol detector; a computing system operably connected to the aerosol detector and comprising hardware and software for executing instructions to perform the methods of the aerosol detection mechanism, whereby the aerosol detection mechanism is configured to differentiate between a fluorescent-tagged aerosol and a non-fluorescent tagged aerosol; and, whereby the aerosol detection mechanism collects time-resolved data correlating aerosol infiltration to the speed of motion and limb position.

According to yet another aspect of the present invention, the size, fit, motion, data collection surfaces, and aerosol challenge processes are all designed to closely replicate the conditions of a human-in-the-garment aerosol system test. This allows the testing system to predict the performance of a full ensemble in a human-in-the-garment I-AST, without requiring the use of a human test participant. A further advantage includes the ability to test high-risk components not yet approved for human use. It is to be understood that the GRIPS disclosed herein may be used not only for the testing of aerosols, but may be used for testing liquids, vapors, and other chemical and biological agents.

In one or more embodiments, the system method includes data collection that provides measurements of several key aspects, including the observed challenge concentration and duration, the amount of aerosol deposited on various locations across the tested body part (such as the palm, back of the hand, forearm volar, forearm dorsum, elbow fold, ears, cheeks, nape, neck, scalp, and scapula), and the visualization of the deposition pattern and intensity over the tested body part.

According to one or more embodiments, a method of using the system to test protective garments comprises the steps of placing the manikin of the system in an exposure chamber; tagging a challenge aerosol with a fluorescent tag; providing an aerosol detection mechanism configured to differentiate between a fluorescent-tagged aerosol and a non-fluorescent tagged aerosol; introducing the challenge aerosol into the chamber for a predetermined duration; activating the biomimetic mechanics and movement of the system; and, analyzing data collected for aerosol penetration through seams, closures, and interfaces of the protective garment.

Other aspects of the present system and method may include corresponding computer systems, apparatus, and computer programs recorded on one or more computer storage devices, each configured to perform the actions of the methods described herein. Implementations of the described testing techniques may include hardware, a method or process, or computer software on a computer-accessible medium. A system of one or more computers can be configured to perform particular operations or protocols by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

These and other aspects, features, and advantages of the presently disclosed subject matter will be set forth in the description that follows.

### BRIEF DESCRIPTION OF THE DRAWINGS

The foregoing, as well as the following Detailed Description, is better understood when read in conjunction with the appended drawings. For the purposes of illustration, there are shown in the drawings exemplary embodiments; however, the presently disclosed subject matter is not limited to the specific methods and instrumentalities disclosed. These and other features, aspects, and advantages of the present invention will become better understood with regard to the following description, appended claims, accompanying drawings, and reference numerals designating corresponding elements where:

FIG. 1A is an anterior view of an embodiment of a full test manikin further illustrating discrete sampling points that may be used for skin sampling according to the AST.

FIG. 1B is a front view illustrating body regions on a male (left) and female (right) that are imaged for regional data collection according to the quantitative imaging analysis of the I-AST.

FIG. 2 is an anterior view of an embodiment of a test manikin donned in a protective ensemble.

FIG. 3 is an anterior view of an embodiment of a head and torso that may be used for hood/mask interface (HMI) testing.

FIG. 4 is a side view of an embodiment of a head and torso illustrating a mask fit test.

FIG. 5A is an anterior view of an embodiment of a head and torso donning a protective garment and illustrating cinching at the waist and wrists.

FIG. 5B is a posterior view of FIG. 5A.

FIG. 6 is a side view of an embodiment of a test manikin's arm donned in protective sleeves and gloves, illustrating wrist flexion.

FIG. 7 is a side view of an embodiment of a test manikin leg, ankle, and foot, illustrating flexion of the ankle.

FIG. 8 is a perspective view of an embodiment of a test manikin's lower torso, legs, and feet donned in protective pants and boots, illustrating a squatting motion at the hips and knees and ankle flexion at the boot interface.

FIG. 9 is a schematic illustrating an embodiment of the GRIPS-HMI test manikin showing the control center housing of the GRIPS test system.

FIG. 10 is a side view and top view of a head and neck, illustrating exemplary head and neck flexion, extension, and rotation.

FIG. 11 is a perspective view of an embodiment of a socket mounting system of the torso, illustrating the rotation motor and a means of removable attachment of the torso to a stand or base.

FIG. 12 is a schematic illustrating the torso rotational movement that may be simulated by the manikin torso.

FIG. 13 is a perspective view of an embodiment of the neck joint.

FIG. 14 is an exploded view of an embodiment of the neck joint removably secured to the interface plate, which is further attached to the head tilt bracket affixed to a motor.

FIG. 15A is a block diagram illustrating an exemplary embodiment of the motor circuit(s) and microprocessor(s) that may be housed within the manikin.

FIG. 15B is a block diagram illustrating an embodiment of the motor circuit(s) and microprocessor(s) that may be housed within the manikin, further including switches for the selection of programmable movements and motion protocols.

FIG. 16A is an anterior view of an embodiment of the manikin torso illustrating one embodiment of a means for cinching a protective garment at the waist of the torso.

FIG. 16B is a posterior view of an embodiment of the manikin torso illustrating an alternative embodiment of a means for cinching a protective garment at the waist of the torso; an access panel for the control housing is also shown.

FIG. 16C is an anterior view of an embodiment of the manikin torso illustrating yet another embodiment of a means for cinching a protective garment at the waist of the torso.

FIG. 17 is a perspective view illustrating an embodiment of the aerosol detection mechanism.

FIG. 18 is an embodiment of a skin sampling ring used in the skin sampling procedure.

FIG. 19A is a demonstration of the skin sampling procedure performed on the neck of the test manikin.

FIG. 19B is a demonstration of the skin sampling procedure performed on the head of the test manikin.

FIG. 20 is an illustration of an embodiment of the automated system for image-based data collection from full body areas.

FIG. 21 is a graph showing aerosol surface concentration by body region of a moving test model compared to a static test model.

FIG. 22 is a graph showing total aerosol deposition recorded on the GRIPS-HMI compared to a static test model.

FIG. 23 is a graph showing aerosol deposition recorded on the hand and arm of a moving test model compared to a static test model.

FIG. 24 is a graph validating the GRIPS capability to discriminate between fluorescent-tagged aerosol and inert aerosol.

### DETAILED DESCRIPTION

To address the foregoing problems, in whole or in part, and/or other problems that may have been observed by persons skilled in the art, the present disclosure provides methods, processes, systems, apparatus, instruments, and/or devices, as described by way of example in implementations set forth below.

The embodiments illustrated, described, and discussed herein are illustrative of the present invention. As these embodiments of the present invention are described with reference to illustrations, various modifications or adaptations of the methods and or specific structures described may become apparent to those skilled in the art. It will be appreciated that modifications and variations are covered by the above teachings and within the scope of the appended claims without departing from the spirit and intended scope thereof. All such modifications, adaptations, or variations that rely upon the teachings of the present invention, and through which these teachings have advanced the art, are considered to be within the spirit and scope of the present invention. Hence, these descriptions and drawings should not be considered in a limiting sense, as it is understood that the present invention is in no way limited to only the embodiments illustrated.

The following description and figures are illustrative and are not to be construed as limiting. Numerous specific details are described to provide a thorough understanding of the disclosure. In certain instances, however, well-known or conventional details are not described in order to avoid obscuring the description. Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. It will be appreciated that same thing can be said in more than one way.

As used herein, the term “anthropomorphic” generally refers to resembling or having human characteristics or attributing human qualities to non-human things. Anthropomorphic is primarily replicating human features and appearance and mimicking the human form.

As used herein, the term “biomimetic” generally refers to the imitation of biological systems or processes found in nature to solve design problems. More specifically, a biomimetic mechanism is designed for imitation of biological processes or models from nature aiming to solve various complex biological problems.

As used herein, the term “aerosol” generally refers to an assembly of liquid or solid particles (or particulates, or particulate matter) suspended in a gaseous medium long enough to be observed and measured. The size of aerosol particles typically ranges from about 0.001 μm to about 100 μm. See Kulkarni et al., Aerosol Measurement, 3rd ed., John Wiley & Sons, Inc. (2011), p. 821. The term “gaseous fluid” generally refers to a gas (or gaseous fluid, or gas-phase fluid). A gas may or may not contain liquid droplets or vapor and may or may not contain aerosol particles. An example of a gas is but is not limited to, ambient air. An aerosol may thus be considered as comprising particles and a gas that entrains or carries the particles.

As used herein, the term “bioaerosol” generally refers to an aerosol in which one or more bio-particles are suspended or carried. The term “bio-particle” generally refers to a biological material or the combination of a biological material and a non-biological particle on which the biological material is carried. That is, a biological material may itself be a particle freely suspended in an aerosol or may be carried on a non-biological particle such that the biological material and the non-biological particle are suspended together in the aerosol. The biological material may be carried on the non-biological particle by any mechanism such as, for example, entrapment, embedment, adhesion, adsorption, attractive force, affinity, etc. Examples of biological materials include but are not limited to, spores (e.g., fungal spores, bacterial spores, etc.), fungi, molds, bacteria, viruses, biological cells or intracellular components, biologically derived particles (e.g., skin cells, detritus, etc.), etc.

As used herein, for convenience the term “aerosol” generally encompasses the term “bioaerosol” and the term “particle” generally encompasses the term “bio-particle,” unless indicated otherwise or the context dictates otherwise.

As used herein, the term “fluid” generally encompasses the term “liquid” as well as the term “gas,” unless indicated otherwise or the context dictates otherwise. Particles suspended or carried in a liquid, as well as particles suspended or carried in an aerosol, may be detected by devices and methods disclosed herein.

Unless defined otherwise, all technical and scientific terms used herein have the same meaning as commonly understood to one of ordinary skill in the art to which the presently disclosed subject matter pertains. Although any methods, devices, and materials similar or equivalent to those described herein can be used in the practice or testing of the presently disclosed subject matter, representative methods, devices, and materials are now described.

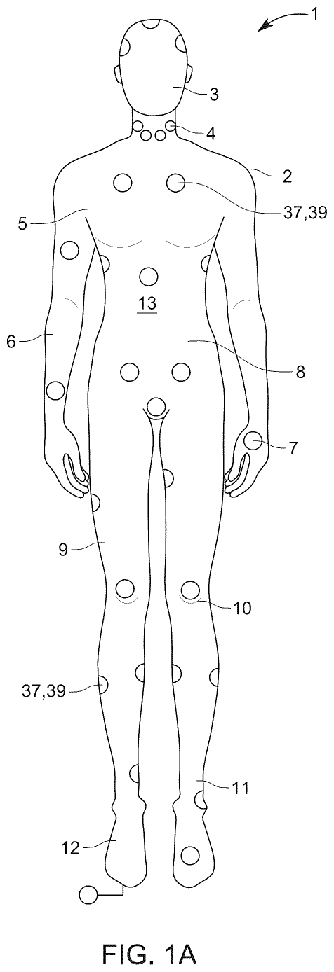

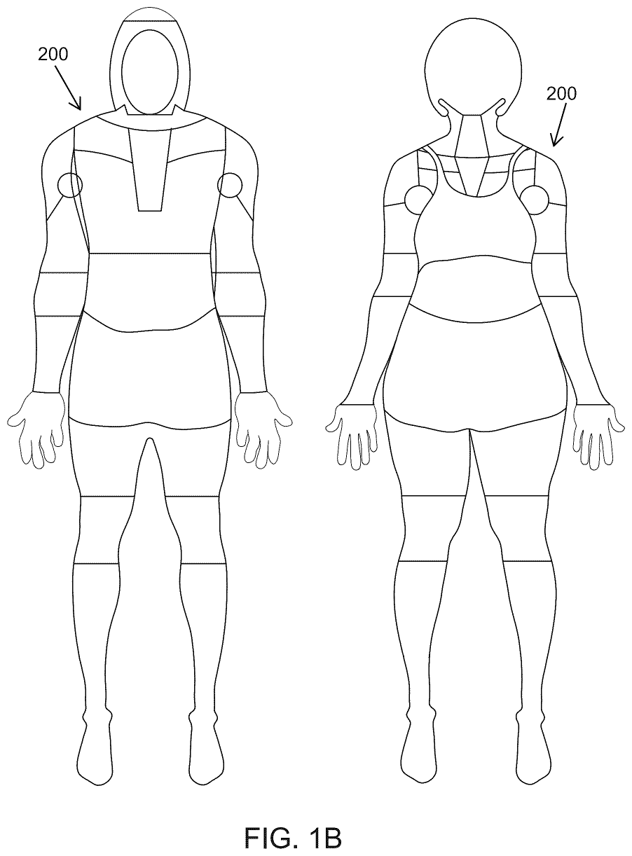

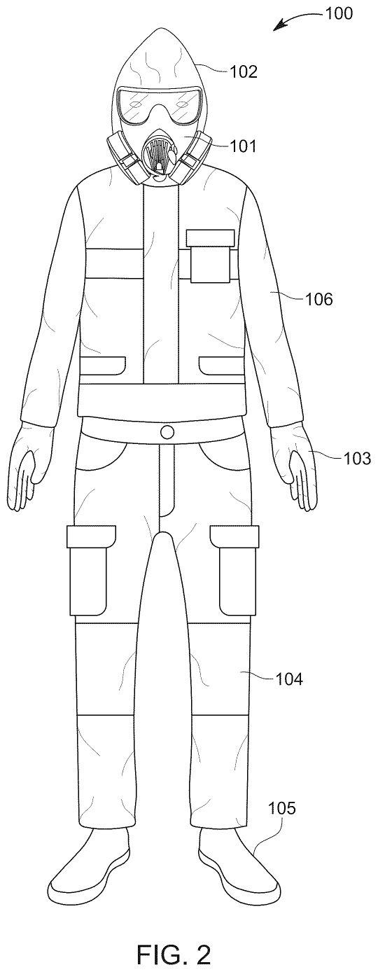

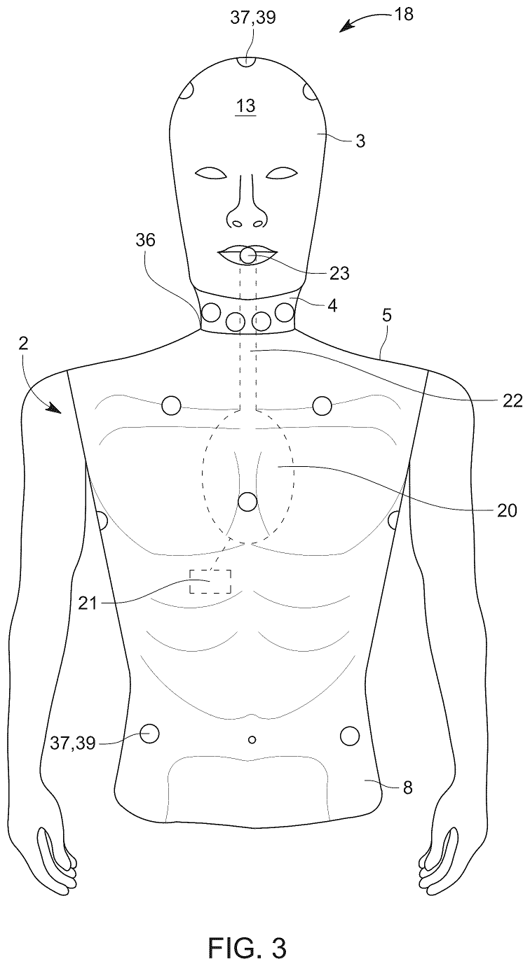

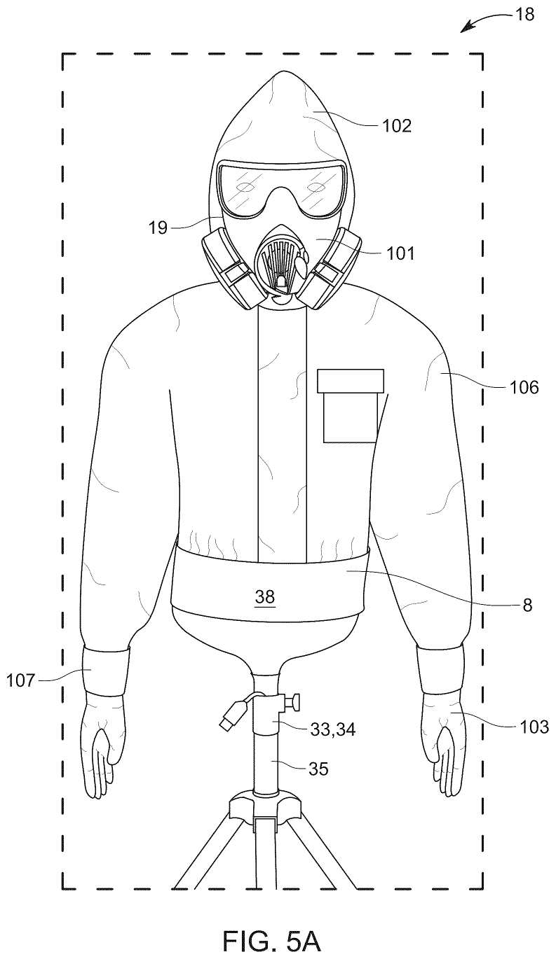

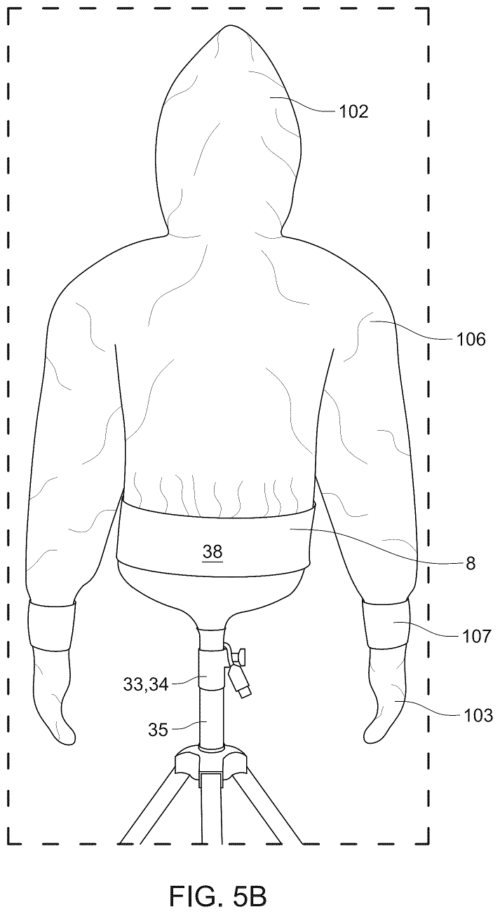

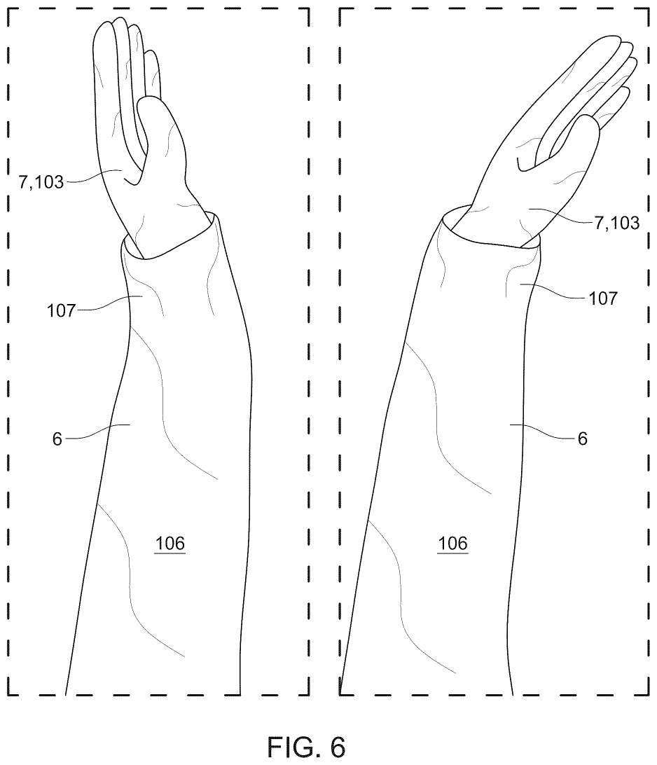

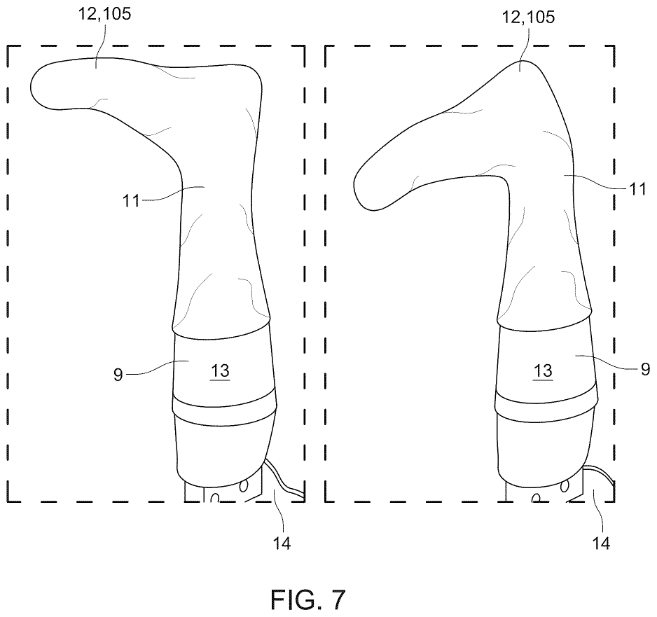

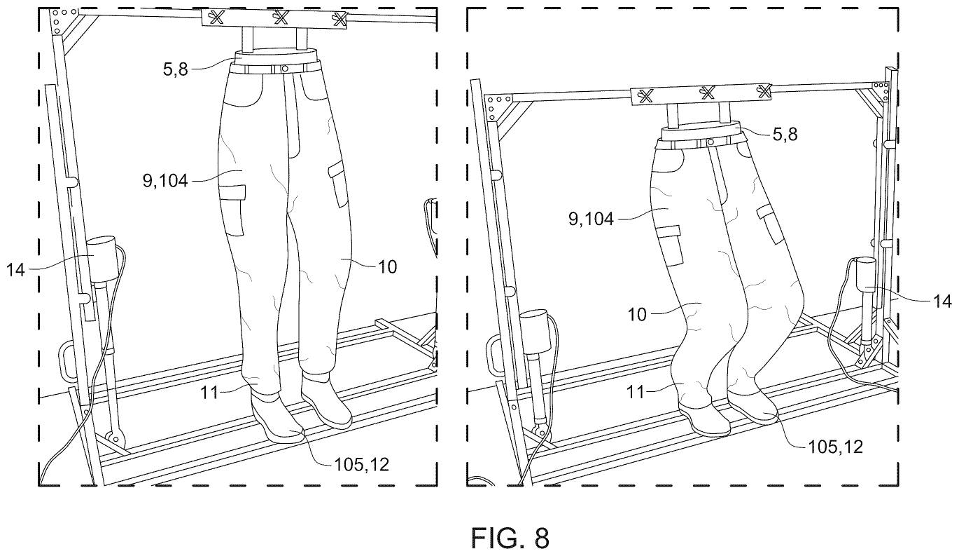

The garment robotic interface system 1 (GRIPS) disclosed herein includes an anthropomorphic test manikin 2 comprising at least one limb component defined as a body part (arm, leg, head, etc.) or area of the body (such as upper torso and head; lower torso, legs, feet; etc.) whereby a protective garment forms closures, interfaces, and seams. The GRIPS test manikin 2 is preferably constructed from a polyethylene (PE), acrylonitrile butadiene styrene (ABS), or similar suitable polymer material and is designed with dimensions and proportions that align with standard human sizes typically used for protective gear 100. In a preferred embodiment, a chassis-based design allows for modular subunits of the body to be interchanged, enabling efficient testing of various body sizes without the need for separate, complete systems for each size. For instance, a torso 5 equipped with all necessary motors and controls can be paired with interchangeable head forms 3 and skin-like coverings 13, facilitating quick switching between head sizes such as extra small, small, medium, and large with minimal time and effort. Similarly, hand sizes, forearms, or biceps can be replaced while utilizing the same chassis for motors and control systems. Additionally, this approach extends to foot and leg systems, where different-sized feet or calves can be swapped to test various boots and pants without requiring an entirely new system. Examples of such human limb components and body areas are shown in FIGS. 1-8 and include, but are not limited to, upper torso 5 and head 3 (mask 101 or mask 101/hood 102/shirt 106) (FIGS. 3-5B), hand 7 and arm 6 (glove 103 or glove 103/shirt sleeve 106) (FIG. 6), the foot 12 and leg 9 (boot 105 or boot 105/pant leg 104) (FIG. 7), and feet 12, legs 9, and torso 5 below the waist (boots 105 and pants 104) (FIG. 8). Alternatively, the GRIPS 1 may comprise an entire body simulation, shown in FIGS. 1 and 2, whereby a full garment ensemble 100 can be tested. FIGS. 1 and 2 illustrate an embodiment of such test manikin 2 prior to testing (FIG. 1) and donned with a protective garment 100 (FIG. 2).

The GRIPS 1 is designed for reuse, longevity, and ease of maintenance. The GRIPS 1 is subjected to repeated aerosol challenge testing which can degrade the components over time. Reduced maintenance and longevity of the equipment can be achieved by shielding the control systems and mechanical components from prolonged aerosol exposure. To prevent the ingress of aerosol into the interior components of the system, these components can be encased in weatherproof housings 40 or sealed within the chassis of the GRIPS 1, thereby protecting them from both environmental elements and the aerosol-laden atmosphere of the testing wind tunnel. By safeguarding critical interior components (such as biomimetic movement means, motors, control systems, pneumatic systems, etc.) within a protective enclosure(s), their operational life can be significantly extended.

The outer surface of the test manikin 2 is engineered and designed to replicate the response of human skin, featuring a covering of flexible, removable, skin-like material 13 suitable for testing and imaging aerosol deposition. These skin-like materials 13 may be the same or similar to those used in movie and theater productions and/or anatomical tattoo practice skins. The skin-like material 13 may be constructed from silicone-based compounds, rubber-based compounds, silicone-rubber blends, polypropylenes, polyurethanes, or any other similar thermoset polymer material, provided the surface closely mimics or replicates the response characteristics of human skin during testing.

Important properties for the skin-like material include strength, flexibility, minimal tackiness or stickiness, and preferably being lightweight. More importantly, the surface of the material preferably does not have pre-existing molecular luminescence (such as fluorescence or phosphorescence) that would interfere with quantitative imaging during the testing process. If the skin-like material is found to have pre-existing luminescence prior to testing, a coating may be applied to the surface of the material that obscures or alters the surface properties, thereby removing the background luminescence of the material itself. Another important consideration is the appearance of the GRIPS to the image acquisition system; materials should appear uniform and be distinguishable from the background to allow automated tracking of body location and efficient aerosol deposition sampling. Additionally, materials should be easily cleanable to remove aerosol deposits following testing and prior to reuse, ensuring the reduction or elimination of residual signal to the lower detection limit, preferably less than three times the lower detection limit, of the data acquisition process.

A sufficient seal between the skin-like material 13 and the manikin 2 is desired to minimize potential aerosol deposition along or within the skin-to-torso interface 36 of the manikin 2. In a preferred embodiment, hook-and-loop fasteners may be used to removably attach the skin-like material 13 to the manikin 2. This method is preferred over alternatives such as snaps or other closures that could potentially leave spacing that allows aerosol ingress between the skin-to-torso interface 36.

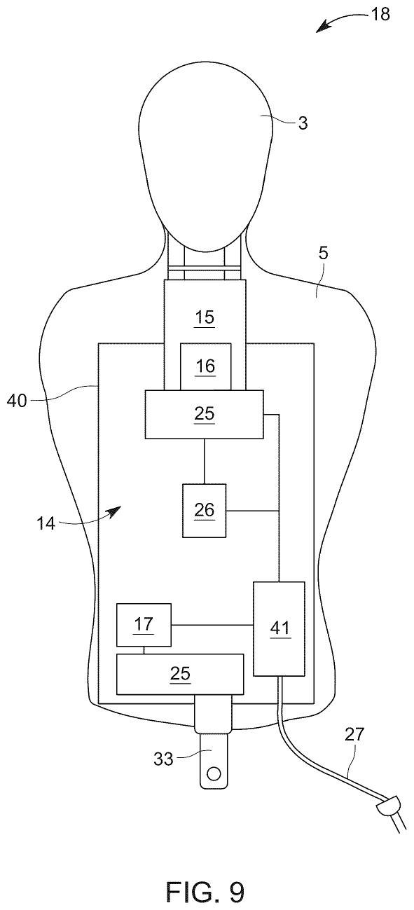

The system is configured to simulate realistic motion and incorporates biomimetic mechanics, such as means for artificial respiration and means for articulation, described herein. The articulation means may include mechanisms such as motors, actuators, joints, and hydraulic and/or pneumatic systems to provide motion, flexibility, and articulation to the limbs. As discussed above, these articulation means are preferably sealed within the system in a way that prevents aerosol ingress into these mechanisms. All components of the system are engineered to withstand and operate under extremely heavy loads while enabling life-like motions. These heavy loads may include body armor, firefighting hoses, helmets equipped with mounted sensors, and firefighting tools such as axes or picks. In a preferred embodiment, shown best in FIGS. 9 and 14, the primary means for articulation is a servo motor 15, 16, 17 or series of servo motors 15, 16, 17 designed for precise control of rotational or linear position, speed, and acceleration of the test manikin. These servo motors 15, 16, 17 operate on a closed-loop feedback system to constantly monitor the position of the manikin and adjust accordingly.

The positioning and arrangement of the articulation means and mechanisms are determined by the specific movements desired. For instance, to enable head 3, neck 4, or waist 8 movement, the articulation mechanisms may be integrated or mounted within the torso 5 of the manikin 2, as shown in FIG. 9. Similarly, for hip/leg 9, or ankle 11 movement, these mechanisms may be positioned within the pelvic region 8 or the legs 9. For arm 6 or hand 7 movements, the articulation mechanisms may be located near the shoulder or within the arm 6 itself. FIG. 6 depicts realistic wrist flexion, while FIG. 7 illustrates natural foot 12 flexion and ankle 11 articulation. FIG. 8 shows a lower torso 5 and extremities donned in pants 104 and boots 105 with legs 9, ankles 11, and feet 12, demonstrating the system's ability to simulate complex movements such as squatting and knee bending, combined with simultaneous ankle flexion.

One embodiment of the present system is the GRIPS head 3 and torso 5 designed specifically for hood-mask interface 19 (HMI) component testing, best shown in FIGS. 3-5B and referred to herein as “GRIPS-HMI” 18. The hood-mask interface 19 remains a critical challenge in air-permeable protective garments, making it important to rigorously evaluate and stress these key interfaces during testing. It is to be understood that the GRIPS-HMI 18 may not be limited to hood-mask interface 19 component testing, but rather it may be used for any testing where a head 3 and torso 5 is suitable or desired.

Testing HMI garments requires head forms 3 of various sizes with dimensions that substantially match human head and face measurements. A preferred embodiment of the head form 3 adheres to realistic human dimensions based on specified guidelines for mask 101 usage. Exact dimensions from official Center of Disease Control (CDC) head form specifications are used to produce models for small, medium, and large head sizes. These CDC specifications are based on National Institute for Occupations Safety and Health (NIOSH) data available in several publications, including the Head-and-face Anthropometric Survey of U.S. Respirator Users (See Zhuang, Z. and Bradtmiller, B., J Occup Environ Hyg. (November 2005), 2(11):567-76), incorporated by reference herein in its entirety. Using anthropometric data gathered during a 2003 NIOSH survey, parameters for new head forms in five size categories were developed by the National Personal Protective Technology Laboratory (NPPTL) of NIOSH. Three-dimensional (3D) scans of five individuals, who most closely represented a given size category were averaged together. The resulting models include facial features not found on current standard head forms. Five distinct sizes (small, medium, large, long/narrow and short/wide) of digital 3D head forms have been created taking into account the overall size and shape of the face. The NIOSH head forms are symmetric and represent the facial size and shape distribution of current U.S. respirator users. In addition, the ears have been placed on the head forms to match the average position for the chosen heads of a given size. These head forms have been incorporated into a technical specification standard for ISO TC94 Personal Protective Equipment, SC15 Respiratory Protective Devices, WG1 General, PG5 Human Factors. That standard is titled “ISO 16976-2 Respiratory Protective Devices—Human Factors—Part 2: Anthropometrics”, incorporated herein by reference in its entirety. With regard to the present invention, these head forms 3 are manufactured to stringent tolerances in accordance with the above data to ensure proper mask 101 fitting and compatibility with testing devices.

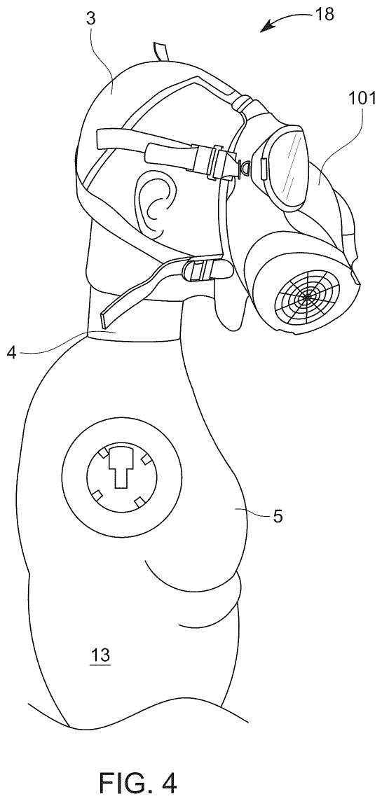

The head forms 3 are designed to accommodate quantitative mask/respirator 101 fit testing using devices such as the TSI PortaCount Model 8020A, for example. FIG. 4 shows the GRIPS-HMI 18 donning a gas mask 101 during a respirator/mask fit test. To simulate breathing during a respirator fit test, the manikin 2 may be equipped with a pneumatic system with inflatable chambers 20 or bellows that expand and contract, mimicking the movement of lungs. These components may be combined with a control system 21 to regulate the rate and depth of the “breaths”. In an alternative embodiment, the GRIPS-HMI 18 may be equipped with a synthetic air flow passage 22 operably connected to a tidal pump 20 and sampling connections to conduct verification testing. The head forms 3 may incorporate access ports for real-time aerosol sampling and an engineered breathing outlet or aperture 22, as shown in FIG. 3, to simulate breathing, thereby enabling a comprehensive evaluation of protective equipment 100.

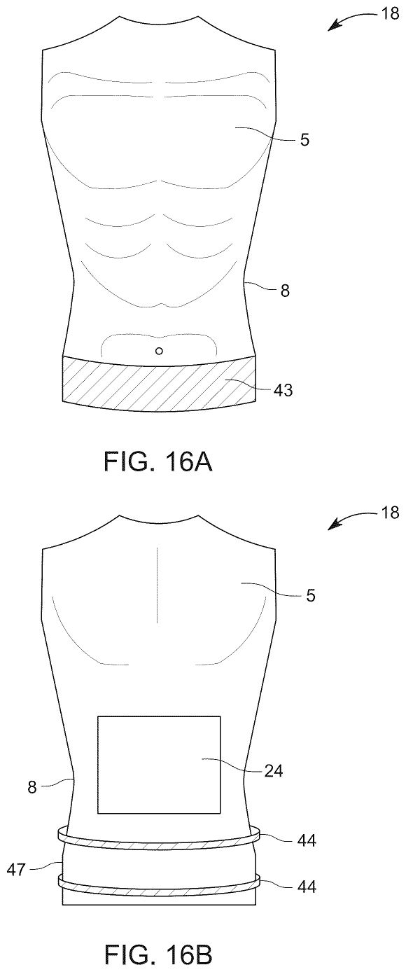

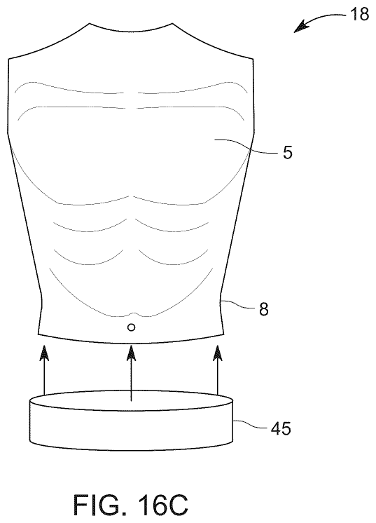

A means for controlling and/or programming the biomimetic mechanics of the test manikin 2 is provided. This means may be a central control center 14 mounted in or near the test manikin 2. In a preferred embodiment, the manikin torso 5 defines a hollow chamber with a housing 40 mounted therein. In FIG. 9, the control center 14 is mounted within this housing 40 and is accessible via an access panel 24 preferably disposed on the posterior torso 5, as shown in FIG. 16B. In this instance, the control center housing 14 encases a plurality of servo motors 15, 16, 17, a central microprocessor 26, and circuit boards 25 for the motors 15, 16, 17 disposed therein. The housing of the control center 14 may be a weatherproof enclosure to protect the interior components from exposure elements and the aerosol-laden environment of the testing wind tunnel. A power source 41 and power cord 27 are operably connected to the test manikin 2 for connection to an electrical outlet/power source to supply power to the system 1.

These motors 15, 16, 17 and other components described herein are designated for biomimetic movements of the test manikin 2. For example, a first servo motor 17 (also referred to herein as “torso rotation motor”) may be operatively installed in a location corresponding to the lower abdominal or umbilical region and is designated for torso 5 rotation. A second servo motor 16 designated for cervical rotation, e.g. swiveling the head 3 left to right, (also referred to herein as “pan motor”) may be operatively installed near the neck region and superior with respect to the torso rotation motor 17. A third servo motor 15 designated for cervical flexion and extension, e.g. tilting the head 3 up and down and side to side, (also referred to herein as “tilt motor”) may be operatively installed near the neck region and proximal to the pan motor 17.

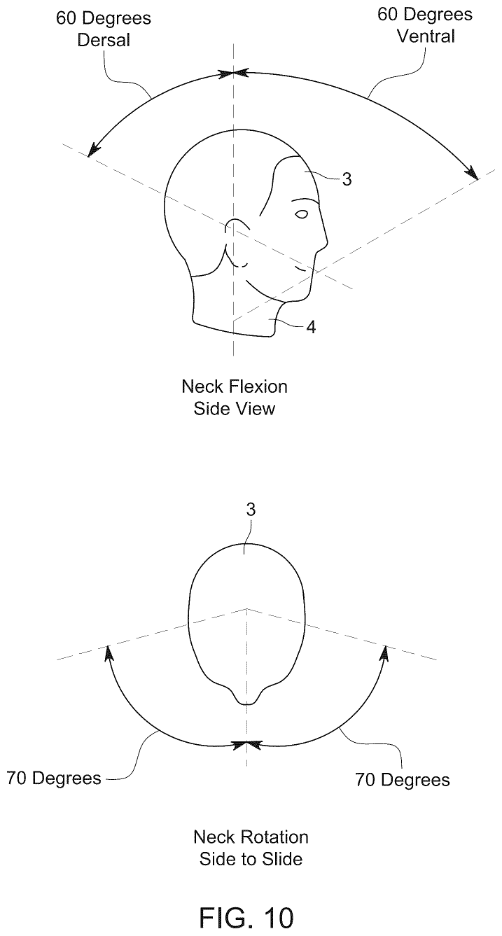

In FIG. 9, the tilt motor 15 is mounted directly above the pan motor 16. FIG. 10 illustrates exemplary head 3 and neck 4 movements using the tilt 15 and pan motors 16. FIG. 10 shows a side view of a head 3 and neck 4, demonstrating neck flexion 60 degrees ventrally (forward tilt) and neck extension 60 degrees dorsally (backward tilt) relative to a neutral position. FIG. 10 also shows a top view of the head 3, illustrating cervical rotation 70 degrees to the right and 70 degrees to the left, relative to the forward-facing neutral position. The axis of rotation mimics alignment with the cervical spine, allowing flexion, extension, and rotation consistent with human biomechanics.

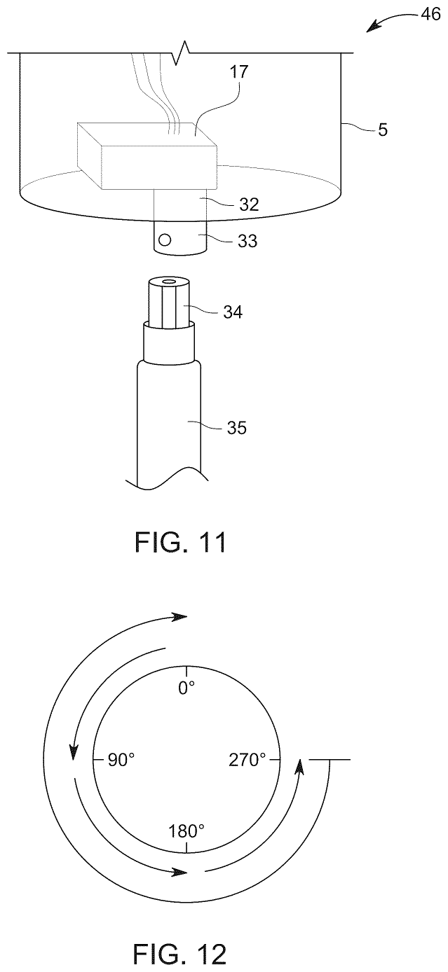

Referring to FIG. 11, torso rotation may be enabled by a servo motor 17 mounted at the base of the manikin torso 5, equipped with a gearbox 32 or operating directly if the motor 17 provides sufficient torque. The servo motor 17 can allow for 270 degrees of rotational movement, with the 0-degree starting position oriented to face the airflow, or side, of an exposure chamber (see FIG. 12). In one or more embodiments, a socket mounting system 46 ensures a secure connection of the torso 5 to the GRIPS 1 while allowing for quick and easy removal during testing. In FIG. 11, a gear is operably connected to a coupling that passes through a pressed-in bearing secured at the base of the manikin torso 5. This coupling interfaces with a female hex socket 33 located on the exterior base of the manikin 2. The male socket bit 34 may be attached to a stand or pole 35, which is mounted within the wind tunnel and aligned with the action points of the test procedure.

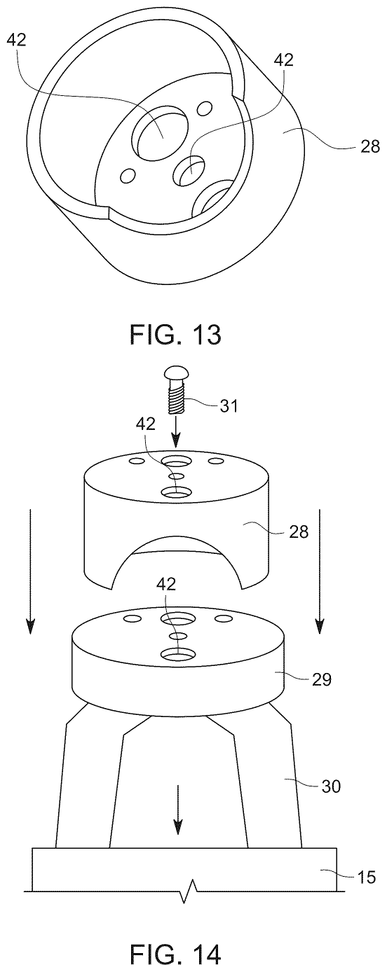

An important feature of the system is the interchangeability of the subunits of the test manikin 2. With regard to the GRIPS-HMI 18, the torso dimensions will typically remain consistent throughout testing; however, the head form sizes will vary depending on the sizes and configurations of the garments to be tested. In a preferred embodiment, the head form 3 is removably attached to the torso 5 with a fastening means that enables quick and efficient removal while maintaining a secure connection. FIGS. 13 and 14 illustrate an embodiment of a neck joint 28 that is removably affixed to an interface plate 29. The neck joint 28 comprises apertures 42 that, when joined with the interface plate 29, align with corresponding apertures 42 of the interface plate 29. These apertures 42 are for fasteners 31, air tubes, or any other testing component (lines, wires, etc.) as needed. The neck joint 28 may be removably secured to the interface plate 29 via thumb screws, cinch pins, or any other suitable quick release means. The interface plate 29 may be directly affixed to a head tilt bracket 30, as shown, which is further operably connected to the servo tilt motor 15.

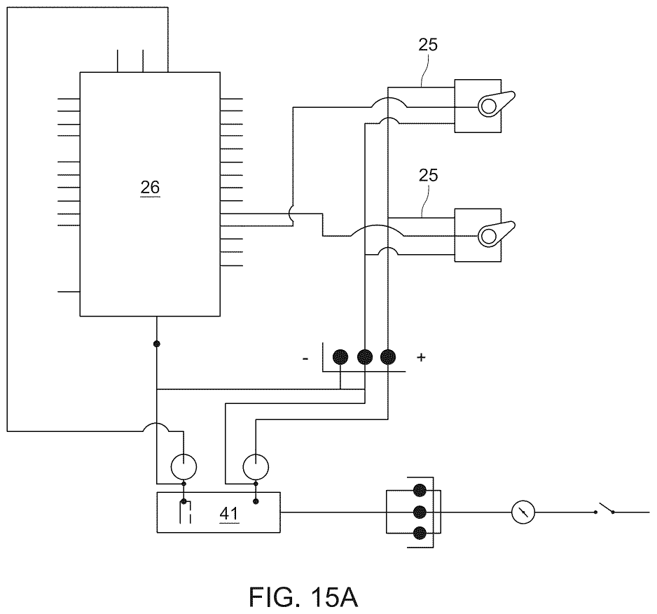

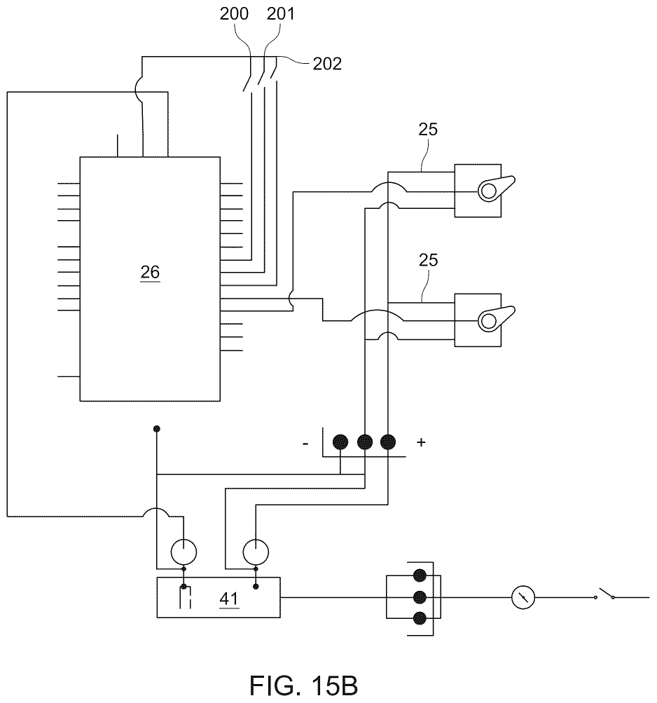

Referring to FIG. 15A, each servo motor is operably connected to a corresponding control circuit 25, and one or more control circuits 25 may be operably connected to at least one microprocessor 26. The microprocessor 26 is configured to transmit control signals to each servo motor, thereby regulating the motor's position. Each servo motor may incorporate an integrated control circuit 25 and a feedback system, enabling real-time adjustments to maintain the desired position. Optionally, a driver circuit may be included to amplify the control signals if the microprocessor 26 lacks the capacity to provide sufficient power directly to the servo motor.

The microprocessor 26 can be programmed to prompt the test manikin 2 to execute specific movements or motion protocols. A motion protocol is defined herein as a series of biomimetic movements that closely replicate a human test subject. These motion protocols are adjustable and re-programmable may be preset “movement routines”, stable or static positioning, or specific tests such as “mask fit test”, for example. As shown in FIG. 15B, additional controls or switches 201, 202, 203 can be added to the circuit to easily select or switch between different pre-programmed motion protocols.

Examples of biomimetic movements include the rotation of the test manikin relative to airflow (or wind) within an exposure chamber. This rotation can be performed as a slow, continuous motion, such as on a turntable, or as discrete angular adjustments with programmable time intervals. For instance, the GRIPS manikin 1 may rotate to specific angles relative to the wind, remaining at each angle for a predetermined duration, such as 7.5 minutes. An example rotation sequence could include facing the wind (0°), rotating to the right side (90°), facing away from the wind (180°), and then rotating to the left side (270° or −90°), completing a full 360° rotation in 30 minutes, as illustrated in FIG. 12.

The GRIPS aerosol testing method may be performed according to the AST or, more preferably, according to the I-AST. The steps and methods of the AST and I-AST, as published, are incorporated herein by reference in their entirety. An important feature of the GRIPS 1 is the compatibility with image-based data collection, as described in detail herein, that correlates with what is seen in human testing.

In general, these tests are conducted by exposing a test participant donning a protective garment ensemble 100 to a tagged aerosol while performing a 30-minute motion routine that simulates real-world activities. The testing conditions (e.g., wind speed, temperature, and humidity) are carefully controlled in a wind tunnel or chamber. After exposure, the garment is carefully removed, and measurements are taken to determine the amount of aerosol that penetrated the protective ensemble and deposited onto body regions of the test participant.

A more detailed description of the GRIPS testing method is described herein. In one example, a wind tunnel may be a sealed room with a vane-axial fan centrally located. Wind speeds up to 20 mph, or even as high as 50 mph with modifications, may be achieved along the test platform. Upon exiting the test section, the air freely expands into the room and recirculates back to the fan intake. To facilitate operations, the test section is mounted on a raised platform providing access from below; overhead access is also available. To allow for testing over a range of ambient conditions, the wind tunnel is equipped with cooling, heating, and humidity controls. Temperatures from approximately 60° F. to 80° F. (15.6° C. to 26.7° C.) and relative humidity ranging from approximately 40% to 80% may be achieved. The ventilation systems of the wind tunnel include a recirculating, high efficiency filtration system for the removal of aerosol from the wind tunnel atmosphere and an ambient air purging system.

The wind tunnel is supported by several auxiliary rooms. A control room is used to set the wind speed, temperature, and humidity; control aerosol samplers; and maintain direct visual contact with the test manikin 2. In addition, the facility includes the staging and doffing room, isolated rooms for background sampling and donning, and a chemistry lab for fluorometric analysis and aerosol preparation. An imaging room provides quantitative imaging with the I-AST equipment and black lights for direct viewing and photographs.

An example of an I-AST includes the following test conditions and aerosol parameters. Specifically, the aerosol challenge can consist of a concentration of 167 mg/m³, with a challenge Ct (concentration×time) of 5,000 mg·min/m³±25%, utilizing a polydisperse aerosol with a mass median diameter spanning a size range of 0.1 μm to 10 μm. The aerosol is tagged with fluorescent and phosphorescent markers to enable deposition and concentration analysis. Environmental conditions include a wind speed of 10 mph±1 mph, temperature of 70° F.±3° F., and relative humidity of 50%+10%. The system 1 also supports testing at additional Cts ranging from approximately 600 to 8,000 mg·min/m³ and varying wind speeds between approximately 3 to 50 mph.

The challenge aerosol is preferably a dry, solid-phase powder composed of two parts (Part A and Part B), although both parts are based on the same synthetic, micron-sized amorphous silica powder (Syloid). In one embodiment, Part A contains a phosphor that is the basis of the I-AST time-gated imaging. For example, Part A may be Syloid 244 amorphous silica as a carrier particle, tetraethylene glycol as a tag solvent, uranine as an analytical fluorescent tag, and tinopal as a visualization fluorescent tag. In one embodiment, Part B is traditional AST powder containing fluorescent tags for analysis and viewing. For example, Part B may be Syloid 244 amorphous silica as a carrier particle and a suitable human-safe phosphor. The use of phosphor and fluorescent tracers allows accurate measurement of submicrogram quantities of deposited aerosol and minimizes background interference (e.g., from ambient aerosol, shed clothing fibers, and carbon dust). The resultant aerosol in the above example has an aerodynamic mass median diameter of approximately 2.5 μm with a geometric standard deviation of approximately 3.2.

To generate the aerosol, the tagged powder is loaded into an auger screw powder feeder. The powder feeder may be operated at approximately 10 g/min (adjusted as needed to maintain desired test conditions). The output from the powder feeder is fed into the intake of a high-volume blower, where turbulence and shear force disperse the powder into the wind tunnel as a fine aerosol.

The test mannikin 2 is assessed for background fluorescence and phosphorescence of the skin-like material prior to testing then donned in a protective garment. To ensure accurate test results, it is important to establish a secure seal around the edges or components of the protective garments 100 to prevent aerosol ingress in areas not under evaluation. According to one or more embodiments, the GRIPS 1 comprises a means for sealing the edges of protective garments that are not under test, such as sealing a sleeve distal to the hand (e.g. near the shoulder region of the arm) when testing the glove-sleeve interface or sealing a shirt at the waist area when testing the hood-mask interface.

FIGS. 16A through 16C illustrate various embodiments for securing a protective garment to the waist area 8 of the GRIPS-HMI 18, thereby preventing aerosol infiltration into the tested region through unintended channels. Referring to FIG. 16A, one embodiment of the sealing means 38 may comprise a spongy or cushioned material 43, such as neoprene or the like, installed circumferentially around the base of the torso 5. This material 43 provides a cushioned surface that facilitates a belt or strap to be cinched or tightened securely around the waist 8.

Another embodiment, illustrated in FIG. 16B, includes one or more guides 44 installed circumferentially around the lower portion of the torso 5. The guide(s) 44 may be a channel routed or carved in the torso 5 such that a belt or strap may be inwardly secured into the guide 44, holding the garment firmly in place. Alternatively, the guides 44 may be a plurality of raised bands installed circumferentially to the surface of the manikin 2 in the lower torso 5 area creating a track 47 around the waist 8 for guiding and cinching a belt or a strap within the track 47.

In yet another embodiment, shown in FIG. 16C, the sealing means comprises a clamp 45 designed to correspond to the shape of the manikin torso 5 (e.g. round or oval) such that the clamp 45 may be secured around the base of the garment. This clamp 45 securely fastens around the garment at the base of the torso 5 and allows for the attachment of a belt or strap for securing closure further. These sealing means 38 ensure the edges of a garment are properly secured (at the waist or any other desired location), preventing aerosol ingress at that location and thereby confining a test aerosol to the intended evaluation area.

Once the manikin 2 has been properly donned and placed in the wind tunnel, a motion routine is initiated. A motion routine for the system 1 under test involves rotating the manikin 2 to different angles relative to the wind (e.g., facing the wind, 90°, etc.), with head movements cycling through a programmed sequence (i.e. motion protocol) at each angle. The typical total test duration is 30 minutes, though a range of durations from less than 10 to more than 60 minutes can be used.

The system 1 can employ an aerosol detection mechanism 50 that can differentiate between the tagged challenge aerosol and inert dust or particles generated by the garment or body part movement. Real-time aerosol detection using FAST technology described herein can discriminate between the fluorescent-tagged aerosol (challenge aerosol) and non-target aerosol (i.e., particle generated by the garment during movement), thereby allowing determination of what motion introduces the most aerosol. The control system can incorporate a programable switching of aerosol sampling lines 51 and conduct verification testing.

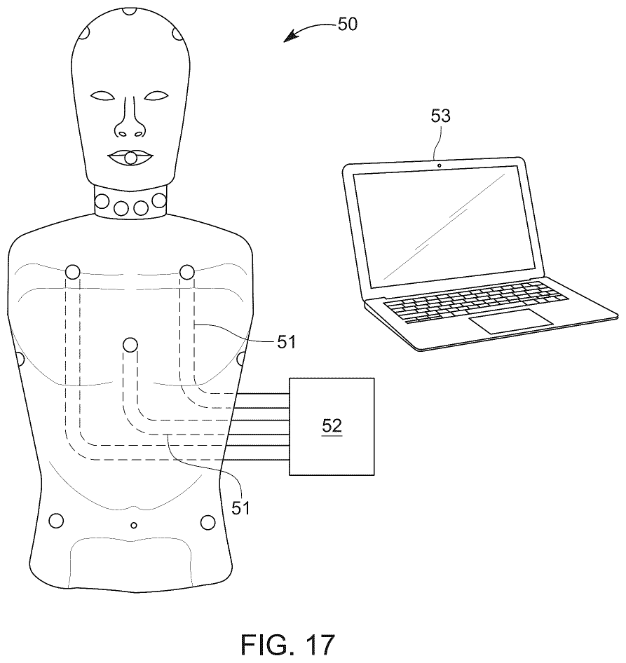

In one or more embodiments, such as illustrated in FIG. 17, the aerosol detection mechanism 50 comprises an aerosol detector 52 with aerosol sampling lines 51 operably connected thereto, and a computing system 53 comprising hardware and software for executing the instructions to perform the method(s) of the FAST. The aerosol detection mechanism 50 can identify increases in aerosol concentrations within the protective garment, equipment, or subsystem during motion or positional changes of the body part. For example, a squatting lower torso 5 with legs 9 and feet 12 could be monitored for aerosol penetration or infiltration in relation to the speed of motion and the position during the squatting routine. Sampling lines 51 may be disposed below the earlobes to sample the temple area under a hood 102, but outside of the mask 101, in such a manner that will not cause interference with the hood mask interface 19.

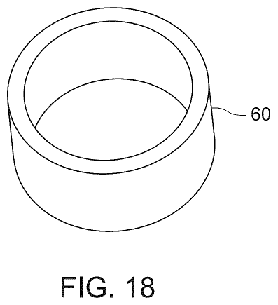

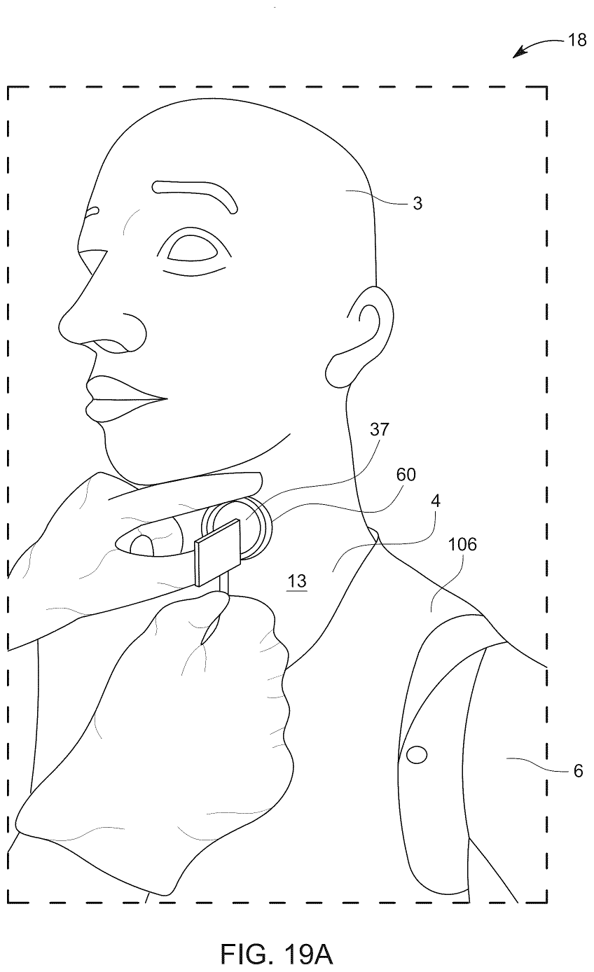

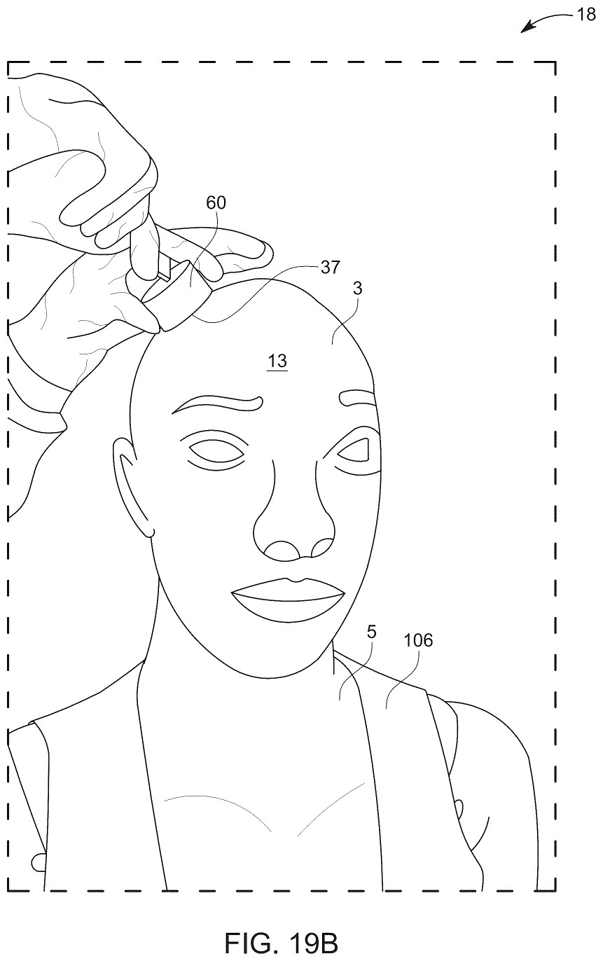

Data can be collected through imaging and/or the skin rinse method. As part of the standard wind tunnel testing procedure, pre- and post-test skin samples can be collected by rinsing the skin surface 13 with deionized (DI) water and a dilute sodium hydroxide solution (0.01 Normal). The collected samples are subsequently analyzed to detect any phosphorescent or fluorescent signals that may result from aerosol deposition or background contamination on the skin surface 13. Skin sampling rings 60 define a skin area to be tested, with FIG. 18 showing an embodiment of the skin sample rings 60 designed to match the sample area dimensions typically tested. FIGS. 19A and 19B illustrate the skin sampling procedure whereby sampling points 37 on the neck 4 and head 3 are swabbed and analyzed.

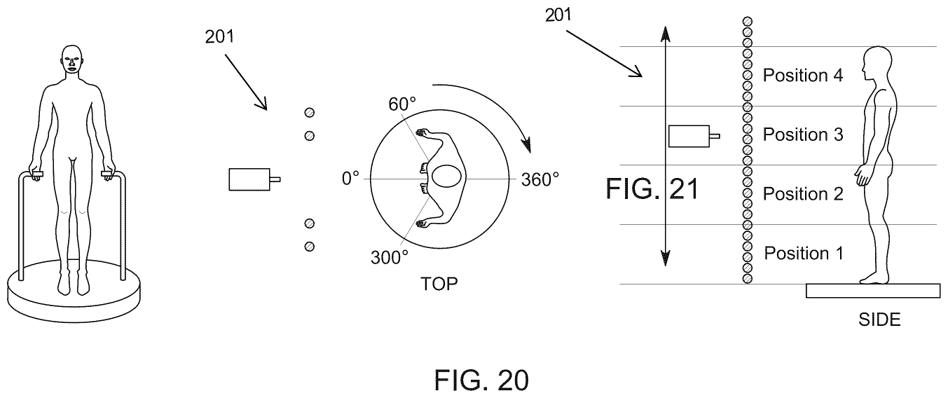

During image-based data collection, aerosol deposition is assessed both visually and quantitatively. Image-based data collection can be discrete, such as from specific spot samples 37 as shown in FIG. 1A, or can be all data by body region 200, as shown in the delineated regions of the male (left) and female (right) bodies represented in FIG. 1B. During image-based data collection, the manikin is imaged under blacklight (FIG. 20) to examine deposition patterns of tagged aerosol, such as hot spots indicated by brightly colored areas, that may indicate areas of infiltration in the protective garment. The GRIPS 1 includes image analysis software that can analyze the surface concentration in discrete sampling spot locations, such as locations 37, according to TTOP 10-2-022A, as well as surface concentration in body regions 200, as illustrated in FIG. 1B. Data from certain body areas or spot samples may be below the limit of detection, thus rinse samples may be used in these locations. Skin-rinse data may also be used for non-imaged areas, hard to image areas, and hotspots.

Data is collected using the fluorescent and phosphorescent tags to quantify the particles deposited on the skin-like material 13, and the body regions 200 are automatically identified in the image analysis software that is run by the GRIPS system 1. Pixel intensities are converted to surface concentration and are used to determine surface concentration by body region 200. The data generated are exported to a data file and can be used in the toxicological data assessment tool.

Time-gated imaging is used to remove any background fluorescence that would otherwise complicate viewing of aerosol deposition under black light. The imaging system 201 scans the body using an automated system operated from a graphical user interface (GUI), as illustrated in FIG. 20. The software uses the sample spot method to determine and report results akin to the skin rinse method of TTOP 10-2-022A. Bright images are acquired under black light, and sampling points are located according to TTOP 10-2-022A. The time-gated images are then acquired. The data are extracted from the gated images at the specific body locations, identified in the bright images, and used to calculate aerosol deposition. Data analysis is performed once full image set of pre-exposure (manikin 2 background fluro) and post-exposure (manikin 2 with aerosol) are acquired.

Data gathered with both the imaging and skin rinse methods are used to calculate the rate of aerosol deposition onto the skin material 13, referred to herein as deposition velocity (DV). The DV uses the amount of aerosol deposited on the skin relative to the Ct and is generally expressed as Equation 1.

$$\begin{matrix}Generalized DV by aerosol mass & \\ V = \frac{( Mass of Deposited Aerosol per Area )}{( {C}_{m} \times T )} & Equation 1\end{matrix}$$

Where,
Cm=Aerosol Mass Concentration (typically in mg/m³)
T=Sample duration (typically in minutes)
   The combination of DVs and deposition patterns help inform garment ensemble performance.

The GRIPS 1 is designed to test a single or multiple systems 1 or test manikins 2 simultaneously, such as two or more, within a single exposure chamber. These systems 1 can be programmed to execute motion protocols either in synchronization or independently, with individual protocols controlled via the central control center 14, providing enhanced flexibility and efficiency in testing configurations. The system 1 is engineered for durability, capable of withstanding repeated exposure and motion operations in environments with heavy particle concentrations ranging from 1 to 350 mg/m³. Each test can last from 10 to 120 minutes, with the system 1 designed for reuse in at least 20 test cycles before requiring replacement or significant maintenance.

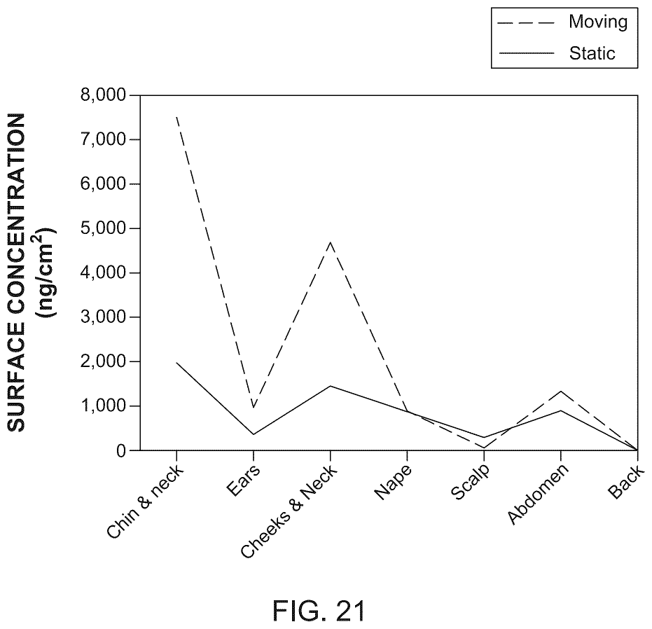

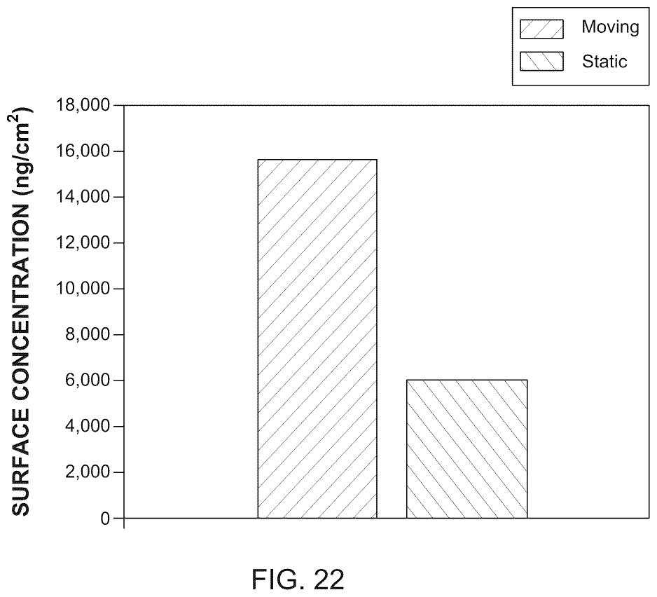

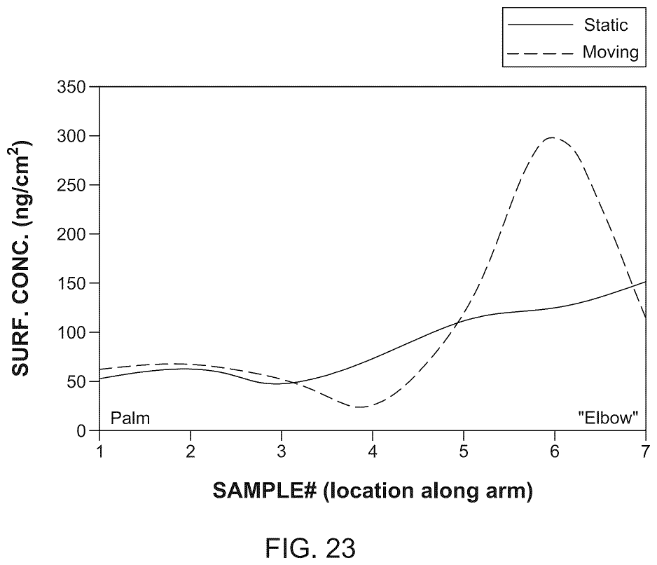

Quantitative results from surface testing after various aerosol tests are shown in FIGS. 21-24. These data demonstrate the importance of the GRIPS-HMI testing system in accurately simulating realistic and dynamic conditions. Surface concentration data by body region are shown in FIG. 21, demonstrating a significant difference in aerosol surface deposition recorded on a moving test subject compared to a static manikin, particularly in the head and torso regions. FIG. 22 shows total aerosol deposition for the GRIPS-HMI compared to a static head and torso manikin, showing an approximate 2.67-fold difference in deposition. Similarly, FIG. 23 depicts total aerosol deposition measurements for the hands and arms, showing a notable difference between the present system and a static manikin under identical test conditions. A large difference can be seen particularly in the elbow region, where a considerable amount of movement and limb articulation occurs.

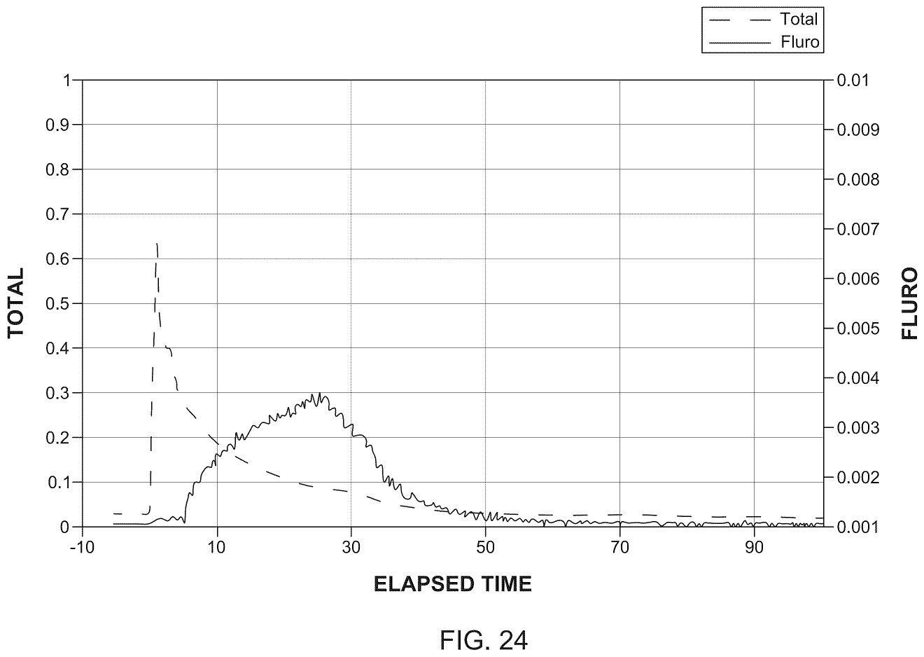

As described herein, the present system comprises the distinctive capability to differentiate between challenge aerosols (e.g. threat aerosols) and benign aerosols (e.g. dust). This functionality is demonstrated by the graph in FIG. 24, which quantifies the GRIPS' ability to distinguish fluorescent-tagged aerosols from inert aerosol. An injection of both inert aerosol (dust) and fluorescent-tagged aerosol was performed at 0 minutes, and total aerosol was monitored and measured over time. FIG. 24 shows the differentiation of the fluorescent-tagged aerosol from the total aerosol (fluorescent-tagged plus inert).

Particular embodiments and features have been described with reference to the drawings. It is to be understood that these descriptions are not limited to any single embodiment or any particular set of features, and that similar embodiments and features may arise or modifications and additions may be made without departing from the scope of these descriptions and the spirit of the appended claims.

These and other changes can be made to the disclosure in light of the above Detailed Description. While the above description describes certain embodiments of the disclosure, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific embodiments disclosed in the specification, unless the above Detailed Description section explicitly defines such terms. Accordingly, the actual scope of the disclosure encompasses not only the disclosed embodiments, but also all equivalent ways of practicing or implementing the disclosure under the claims.

While the invention has been described with respect to certain exemplary embodiments, the embodiments are intended to be illuminating rather than limiting. Modifications and changes may be made within the scope of the invention, which is defined by the appended claims.

What is claimed is:

1. A system for testing protective garments comprising:
an anthropomorphic manikin designed for biomimetic mechanics and movement comprising:
at least one human limb component dimensioned to fit standard sizes of protective garments;
at least one biomimetic mechanism operably connected to the limb component;
a skin-like material removably affixed to an outer surface of the limb component, whereby the skin-like material is designed for mimicking response characteristics of human skin;
a control center comprising hardware for executing system test methods; and
a power supply operably connected to the anthropomorphic manikin.

2. The system of claim 1, wherein the biomimetic mechanism is a means for articulation comprising:
at least one motor operably connected to the manikin;
at least one circuit board operably connected to the motor; and
whereby the control center includes at least one microprocessor configured to transmit signals to the circuit board for execution of programmable motion protocols that activate predetermined biomimetic responses.

3. The system of claim 1, whereby the skin-like covering is constructed from a material selected from the group consisting of silicone-based compounds, rubber-based compounds, silicone-rubber blends, polypropylenes, polyurethanes, and thermoset polymer compounds.

4. The system of claim 1, whereby the skin-like material is attached to the manikin with minimal spacing therebetween to minimize the introduction of aerosol into an interface between the skin-like material and the manikin, and the skin-like material provides a surface for the manikin that is cleanable to level such that background fluorescence under black light exposure is less than three times a lower limit of detection.

5. The system of claim 1, whereby the biomimetic mechanism is programmed for predetermined movements of the human limb component for predetermined durations.

6. The system of claim 1, further including a real-time aerosol detection mechanism comprising:
an aerosol detector configured to identify an increase in aerosol concentrations within a protective garment in relation to a speed of motion and manikin position during movements;
sampling points having a spatial distribution and placement location on the manikin corresponding to standard sampling points used in human aerosol testing;
aerosol sampling lines operably connecting the sampling points of the manikin to the aerosol detector;
a computing system operably connected to the aerosol detector and comprising hardware and software for executing instructions to perform the methods of the aerosol detection mechanism;
whereby the aerosol detection mechanism is configured to differentiate between a fluorescent-tagged aerosol and a non-fluorescent tagged aerosol; and
whereby the aerosol detection mechanism collects time-resolved data correlating aerosol infiltration to the speed of motion and limb position.

7. The system of claim 1, wherein the human limb component comprises at least a head form operably connected to at least a torso.

8. The system of claim 7, further including an artificial respiration mechanism for performing mask fit testing, the artificial respiration mechanism comprising:
at least one inflatable chamber housed in the torso and operably connected to at least one air flow passage line;
a breathing aperture in an area of the head form corresponding to a human mouth, whereby the air flow passage line extends from the inflatable chamber and through the breathing aperture.

9. A system for testing protective garments comprising:
an anthropomorphic manikin torso, whereby the torso defines a hollow chamber that sufficiently seals the interior of the manikin to prevent ingress of an aerosol;
an anthropomorphic neck removably secured to the torso;
an anthropomorphic head form having a first dimension and removably secured to the neck via a quick-release fastening means, whereby the head form is capable of being removed from the neck and replaced with an alternate head form having a dimension different from the first dimension;
a control center mounted within the chamber of the torso comprising at least one biomimetic mechanism installed therein;
a skin-like material removably affixed to an outer surface of the torso and head form, whereby the skin-like material is designed for mimicking response characteristics of human skin and is substantially free of background bioluminescence; and
whereby the head form is operably connected to at least one articulation means for flexion, extension, and rotation of the head form upon the neck.

10. The system of claim 9, whereby the articulation means comprises:
at least one servo motor operably connected to at least one circuit board; and
at least one microprocessor configured to transmit signals to the circuit board for execution of programmable motion protocols that activate predetermined biomimetic movements.

11. The system of claim 9, whereby the head forms are dimensioned based on official size specifications developed by the National Personal Protective Technology Laboratory of the National Institute for Occupational Safety and Health and are compatible with respirator fit testing devices.

12. The system of claim 9, further including an artificial respiration mechanism for performing mask fit testing, the artificial respiration mechanism comprising:
at least one inflatable chamber housed in the torso and operably connected to at least one air flow passage line;
a breathing aperture in an area of the head form corresponding to a human mouth, whereby the air flow passage line extends from the inflatable chamber and through the breathing aperture.

13. The system of claim 10, whereby the at least one biomimetic mechanism installed in the torso comprises:
a plurality of servo motors, including:
a first servo motor operatively installed in a location corresponding to a lower abdominal region of the torso;
a second servo motor operatively installed near the neck and superior to the first servo motor;
a third servo motor operatively installed near the neck, superior to the first servo motor and proximal to the second servo motor;
a microprocessor configured to transmit signals to the circuit board for execution of programmable motion protocols that activate predetermined biomimetic movements.

14. The system of claim 9, whereby:
the head form is removably secured to the neck via a neck joint that is removably affixed to an interface plate;
wherein both the neck joint and the interface plate comprise apertures adapted for fasteners, wires, and tubes to fit therethrough, and whereby the apertures of the neck joint align in correspondence with the apertures of the interface plate;
whereby the neck joint is removably affixed to the head form; and
the interface plate is affixed to a servo motor.

15. The system of claim 9, further including an image-based data collection system comprising:
a real-time aerosol detection mechanism comprising:
an aerosol detector configured to identify an increase in aerosol concentrations within a protective garment in relation to a speed of motion and manikin position during movements;
sampling points having a spatial distribution and placement location on the manikin corresponding to standard sampling points used in human aerosol testing;
aerosol sampling lines operably connecting the sampling points of the manikin to the aerosol detector;
whereby the aerosol detection mechanism is configured to differentiate between a fluorescent-tagged aerosol and a non-fluorescent tagged aerosol; and
whereby the aerosol detection mechanism collects time-resolved data correlating aerosol infiltration to the speed of motion and limb position; and
at least one black light for imaging fluorescent and phosphorescent tagged aerosols;
at least one camera for acquiring images; and
a computing system operably connected to the system and comprising hardware and software for executing instructions to perform methods of the image-based data collection system.

16. A method of using the system of claim 9 to test protective garments, comprising:
placing the manikin of the system in an exposure chamber;
tagging a challenge aerosol with a fluorescent tag;
providing an aerosol detection mechanism configured to differentiate between a fluorescent-tagged aerosol and a non-fluorescent tagged aerosol;
introducing the challenge aerosol into the chamber for a predetermined duration;
activating the biomimetic mechanics and movement of the system; and
analyzing data collected for aerosol penetration through seams, closures, and interfaces of the protective garment.

17. The method of claim 16, whereby the testing is performed in accordance with the Improved Aerosol System Test method as described herein.

18. A method of testing protective garments for aerosol penetration, comprising the steps of:
providing an anthropomorphic manikin;
engineering the manikin for biomimetic mechanics and movement;
covering the manikin with a skin-like material designed for mimicking response characteristics of human skin;
providing an aerosol detection mechanism configured to differentiate between a fluorescent-tagged aerosol and a non-fluorescent tagged aerosol;
donning the manikin in a protective garment and sealing the garment interfaces;
introducing an aerosol challenge;
activating the biomimetic mechanics and movement of the manikin;
collecting samples from the skin-like material for analysis; and
analyzing data collected for aerosol penetration through seams, closures, and interfaces of the protective garment.

19. The method of claim 18, further comprising the steps of:
activating an artificial respiration mechanism, whereby the artificial respiration mechanism is housed within the anthropomorphic manikin; and
simulating breathing during the test.

20. The method of claim 18, further comprising the steps of:
performing quantitative image-based data collection; and
calculating the rate of aerosol deposition (DV) on the manikin using the equation
$$DV = \frac{( Mass of Deposited Aerosol per Area )}{( {C}_{m} \times T )}$$
Where Cₘ=Aerosol Mass Concentration
T=Sample duration.
